(19) United States
(12) Patent Application Publication
(10) Pub. No.: US 2026/0092169 A1
(43) Pub. Date: Apr. 2, 2026

(54) ALL-STEEL SNOW TIRE TREAD AND PREPARATION METHOD THEREOF

(71) Applicant: SHANDONG LINGLONG TIRE CO., LTD., YANTAI (CN)

(72) Inventors: FENG WANG, YANTAI (CN); SHULEI WANG, YANTAI (CN); TAO SUN, YANTAI (CN); JUNYING WANG, YANTAI (CN); ZHENLING WANG, YANTAI (CN); TAO XING, YANTAI (CN)

(73) Assignee: SHANDONG LINGLONG TIRE CO., LTD., YANTAI (CN)

(21) Appl. No.: 19/342,614

(22) Filed: Sep. 28, 2025

Related U.S. Application Data
(63) Continuation of application No. PCT/CN2023/141065, filed on Dec. 22, 2023.

(51) Int. Cl. C08L 7/00; B60C 1/00; C08K 3/04

(52) U.S. Cl. CPC C08L 7/00; B60C 1/0016; C08K 3/04; B60C 2200/04; C08K 2201/006

(57) ABSTRACT

The present application provides an all-steel snow tire tread, consisting of the following raw materials in parts by weight: 50-80 parts of natural rubber, 20-50 parts of solution polymerized styrene butadiene rubber with dual glass transition temperatures, 40-60 parts of carbon black, 10-20 parts of white carbon black with a high specific surface area, 1-2.5 parts of silane coupling agent, 5-10 parts of modified anti-wet skid resin, 2-5 parts of zinc oxide, 1-3 parts of stearic acid, 1-3 parts of anti-aging agent 4020, 1-3 parts of anti-aging agent RD, 1-3 parts of protective wax, 1-1.8 parts of sulfur, and 1-1.5 parts of promoter NS.

### CROSS-REFERENCE TO RELATED APPLICATION

This application claims the priority to Chinese patent application No. 2023117542181, entitled “all-steel snow tire tread and preparation method thereof”, filed to China National Intellectual Property Administration on Dec. 19, 2023. The entirety of the above-mentioned patent application is hereby incorporated by reference herein and made a part of this specification.

### TECHNICAL FIELD

The present application relates to the technical field of all-steel snow tires, and particularly to an all-steel snow tire tread and preparation method thereof.

### BACKGROUND

With the development of the tire industry and the upgrading and iteration of technology, the market segmentation and demand diversification of tires are also increasing. In regions with low temperatures and icy weather throughout the year, the use of winter tires is receiving increasing attention from car users. Winter tires are mainly used on low-temperature and icy roads, which requires the tire tread rubber to have lower hardness at low temperatures than ordinary tires, and to have excellent grip performance on icy and snowy roads to improve tire handling and ensure driving safety. Unlike semi-steel snow tires, all-steel snow tires have a large load, and are worn fast. Moreover, most of the users would not change tires after winter and continue to use snow tires. As can be seen that all-steel snow tires not only need to have good resistance to wet sliding and grip on icy and snowy roads, but also need excellent wear resistance and low rolling resistance, to meet the high-performance requirements of long service life and low fuel consumption of tires.

When designing the formula for the all-steel snow tire tread, in the related technology, a certain amount of butadiene rubber is usually used in the natural rubber system. The butadiene rubber has a glass transition temperature Tg of −100° C., which has the most excellent cold resistance of synthetic rubber. It can reduce the hardening degree of the tread rubber at low temperatures and improve the contact area between the tire tread and the ground. However, the butadiene rubber has a poor anti wet sliding ability. When designing the formula for all-steel snow tire tread, in order to further improve the anti-wet skid performance of the tread rubber, patents CN105086005B and CN105037824B use solution polymerized styrene butadiene rubber with a Tg close to natural rubber, or use oil filled neodymium-based butadiene rubber with a lower Tg, as well as highly dispersed white carbon black commonly used in semi-steel snow tires together. The prepared tread rubber has moderate hardness, good elasticity, and superior anti-wet skid performance in cold snowy ground.

Compared with butadiene rubber, incorporating solution polymerized styrene butadiene rubber with a Tg close to natural rubber can improve the ice grip (tan δ @−25° C.) and wet grip (tan δ @ 0° C.) of the tread, but at the same time, it will increase the heat generation of the rubber material (tan δ @ 60° C.), resulting in an increase in rolling resistance of the tires. The highly dispersed white carbon black has a relatively small specific surface area, making it easy to be dispersed in rubber matrix. However, its reinforcement to rubber is insufficient, and there is still a big room for improvement in wear resistance of tires.

### SUMMARY

The present application provides an all-steel snow tire tread and preparation method thereof to solve the defects in the prior art.

On one hand, the present application provides an all-steel snow tire tread, consisting of the following raw materials in parts by weight: 50-80 parts of natural rubber, 20-50 parts of solution polymerized styrene butadiene rubber with dual glass transition temperatures, 40-60 parts of carbon black, 10-20 parts of white carbon black with a high specific surface area, 1-2.5 parts of silane coupling agent, 5-10 parts of modified anti-wet skid resin, 2-5 parts of zinc oxide, 1-3 parts of stearic acid, 1-3 parts of anti-aging agent 4020, 1-3 parts of anti-aging agent RD, 1-3 parts of protective wax, 1-1.8 parts of sulfur, and 1-1.5 parts of promoter NS.

According to the all-steel snow tire tread provided by the present application, the solution polymerized styrene butadiene rubber with dual glass transition temperatures has dual glass transition temperatures, with a first Tg of less than −70° C. and a second Tg range from −55° C. to −35° C., and has a peak value of loss factor of lower than that of an ordinary solution polymerized styrene butadiene rubber with a single glass transition temperature having a low glass transition temperature.

According to the all-steel snow tire tread provided by the present application, the carbon black is N115 or N220.

According to the all-steel snow tire tread provided by the present application, the white carbon black with a high specific surface area has a specific surface area of 220-300 m²/g determined by BET and an absorption value of dibutyl phthalate of 250-300 cm³/100 g.

According to the all-steel snow tire tread provided by the present application, the silane coupling agent is Si-75, and a weight ratio of the silane coupling agent to the white carbon black with a high specific surface area is 1:10-1.4:10.

According to the all-steel snow tire tread provided by the present application, the modified anti-wet skid resin is a copolymer resin of modified styrene and dicyclopentadiene.

According to the present application, the preparation method for the all-steel snow tire tread is as follows:
(a) feeding the natural rubber, the solution polymerized styrene butadiene rubber with dual glass transition temperatures, a part of the carbon black, the white carbon black with a high specific surface area, and the silane coupling agent into an internal mixer for mixing for 40-50 seconds, the internal mixer is operated at a rotation speed of 40-55 rpm, and a ram pressure of 45-55 N/cm², lifting the ram and holding for 5-15 seconds twice, and discharging a rubber as sheets when a mixing temperature is 150-155° C., to obtain a one-stage master batch;
(b) feeding the one-stage master batch, rest of the carbon black, the zinc oxide, the stearic acid, the modified anti-wet skid resin, the anti-aging agent 4020, the anti-aging agent RD, and the protective wax into an internal mixer for mixing for 10-30 seconds, the internal mixer is operated at a rotation speed of 45-50 rpm, and a ram pressure of 45-55 N/cm², and discharging a rubber as sheets when a mixing temperature is 155-165° C., to obtain a two-stage master batch; and
(c) feeding the two-stage master batch, the sulfur, and the promoter NS into an internal mixer for mixing for 20-30 seconds, the internal mixer is operated at a rotation speed of 20-25 rpm, and a ram pressure of 40-45 N/cm², and discharging a rubber as sheets when a mixing temperature is 100-110° C., to obtain a tread rubber.

The all-steel snow tire tread and preparation method thereof provided by the present application achieve the following technical effects: the prepared all-teel snow tire tread rubber has two glass transition temperatures, with a first glass transition temperature of less than or equal to −60° C., suitable for cold regions, and a second glass transition temperature of less than or equal to −20° C. and greater than or equal to −40° C., having a low modulus at low temperatures, a superior anti-wet skid and grip performance on icy and snowy roads, while reducing heat generation and improving wear resistance by more than 20% compared to existing all-steel snow tire products, which meets the high-performance requirements of tires for use in cold regions and for fuel saving and high wear mileage after winter or when driving to non-cold regions across regions.

1. By using solution polymerized styrene butadiene rubber with dual glass transition temperatures (Tg), the first Tg of solution polymerized styrene butadiene rubber is less than −70° C., the second Tg temperature ranges from −55° C. to −35° C., and the peak value of loss factor is lower than that of ordinary low Tg solution polymerized styrene butadiene rubber with a single glass transition temperature, so that the all-steel snow tread rubber has two glass transition temperatures, moderate hardness at low temperatures, low elastic modulus at −25° C., high loss factor tan & value at 0° C., and low loss factor tan δ value at 60° C., balancing high ice and snow grip performance, anti-wet skid performance, and low heat generation performance.

2. By using the white carbon black with a high specific area, having a BET specific surface area of 220-300 m²/g and a dibutyl phthalate absorption value of 250-300 cm³/100 g, and adjusting the composition and optimizing the ratio to silane coupling agent Si75, the puncturing water film can be improved to ensure the grip on wet and icy ground, while the wear resistance is significantly improved compared to the tread rubber material using the highly dispersed white carbon black with low specific surface area, and is close to that of pure carbon black filled tread rubber.

3. By using copolymer resin of modified styrene and dicyclopentadiene, the compatibility between the resin and rubber is excellent, which can improve the anti-wet skid performance of the tread rubber and reduce rolling resistance at the same time. While ensuring the superior grip on icy and snowy ground of all-steel snow tires, the rolling resistance is further reduced and the wear resistance is significantly improved, which can greatly meet the safety needs of truck and bus users when using in low-temperature icy and snowy regions, as well as the high-performance requirements of tires for low fuel consumption and the high-performance requirements of tires for fuel saving and high wear mileage after winter or when driving to non-cold regions across regions.

The present application utilizes solution polymerized styrene butadiene rubber with dual glass transition temperatures, white carbon black with a high specific area, copolymer resin of modified styrene and dicyclopentadiene, and optimizes the ratio of the components to produce an all-steel tread rubber with low clastic modulus at low temperatures, strong grip on ice, snow and wet ground, and low rolling resistance. The wear resistance has been improved by more than 20%, meeting the tire's requirements for fuel efficiency and high mileage when used in cold regions, as well as when driving to non-cold regions without replacing snow tires. The current problems of insufficient reinforcement of tire tread rubber and the need for improving wear resistance of tires are solved.

### BRIEF DESCRIPTION OF DRAWINGS

A brief introduction will be given to the accompanying drawings used in the examples or the related art description, in order to illustrate the technical solutions of the present application or the related art more clearly. Obviously, the accompanying drawings described below are some examples of the present application. For those skilled in the art, other drawings can be obtained based on these drawings without creative labor.

FIG. 1 shows the DMA temperature scan curves of the tread rubber prepared in Comparative example 1 and Example 4 of the present application.

### DETAILED DESCRIPTION OF THE EMBODIMENTS

A further detailed description of the specific embodiments of the present application will be provided in combination with example below. The following examples are used to illustrate the present application, but not to limit the scope of the present application. Obviously, the described examples are only a part of the examples of the present application, not all the examples. Based on the examples of the present application, all other examples obtained by ordinary skilled persons in the art without creative labor are within the protection scope of the present application.

In order to better understand the purpose of the present application, a further detailed description of the present application will be provided below.

The all-steel snow tire tread of the present example consists of the following raw materials in parts by weight: 50-80 parts of natural rubber, 20-50 parts of solution polymerized styrene butadiene rubber with dual glass transition temperatures, 40-60 parts of carbon black, 10-20 parts of white carbon black with a high specific surface area, 1-2.5 parts of silane coupling agent, 5-10 parts of modified anti-wet skid resin, 2-5 parts of zinc oxide, 1-3 parts of stearic acid, 1-3 parts of anti-aging agent 4020, 1-3 parts of anti-aging agent RD, 1-3 parts of protective wax, 1-1.8 parts of sulfur, and 1-1.5 parts of promoter NS.

To further optimize the above technical solution, the solution polymerized styrene butadiene rubber with dual glass transition temperatures has dual glass transition temperatures, with a first Tg of less than −70° C. and a second Tg range from −55° C. to −35° C., and has a peak value of loss factor of lower than that of an ordinary solution polymerized styrene butadiene rubber with a single glass transition temperature having a low glass transition temperature.

To further optimize the above technical solution, the carbon black is N115 or N220.

To further optimize the above technical solution, the white carbon black with a high specific surface area has a specific surface area of 220-300 m²/g determined by BET and an absorption value of dibutyl phthalate of 250-300 cm³/100 g.

To further optimize the above technical solution, the silane coupling agent is Si-75, and a weight ratio of the silane coupling agent to the white carbon black with a high specific surface area is 1:10-1.4:10.

To further optimize the above technical solution, the modified anti-wet skid resin is a copolymer resin of modified styrene and dicyclopentadiene.

To further optimize the above technical solution, the preparation method for the all-steel snow tire tread is as follows:
(a) feeding 70 parts of natural rubber, 30 parts of solution polymerized styrene butadiene rubber with dual glass transition temperatures, a part of the carbon black, the white carbon black with a high specific surface area, and the silane coupling agent into an internal mixer for mixing for 40-50 seconds, the internal mixer is operated at a rotation speed of 40-55 rpm, and a ram pressure of 45-55 N/cm², lifting the ram and holding for 5-15 seconds twice, and discharging a rubber as sheets when a mixing temperature is 150-155° C., to obtain a one-stage master batch;
(b) feeding the one-stage master batch, rest of the carbon black, the zinc oxide, the stearic acid, the modified anti-wet skid resin, the anti-aging agent 4020, the anti-aging agent RD, and the protective wax into an internal mixer for mixing for 10-30 seconds, the internal mixer is operated at a rotation speed of 45-50 rpm, and a ram pressure of 45-55 N/cm², and discharging a rubber as sheets when a mixing temperature is 155-165° C., to obtain a two-stage master batch; and
(c) feeding the two-stage master batch, the sulfur, and the promoter NS into an internal mixer for mixing for 20-30 seconds, the internal mixer is operated at a rotation speed of 20-25 rpm, and a ram pressure of 40-45 N/cm², and discharging a rubber as sheets when a mixing temperature is 100-110° C., to obtain a tread rubber.

### Example 1

70 parts of natural rubber, 30 parts of solution polymerized styrene butadiene rubber with dual glass transition temperatures, 25 parts of carbon black, 15 parts of highly dispersed white carbon black, and 1.2 parts of silane coupling agent were fed into an internal mixer and mixed for 45 seconds. The internal mixer was operated at a rotation speed of 50 rpm, and a ram pressure of 50 N/cm². The ram was lifted twice and held for 10 seconds each time. When the mixing temperature was 150° C., the rubber was discharged as sheets, to obtain a one-stage master batch;
the one-stage master batch, 25 parts of carbon black, 3 parts of zinc oxide, 2 parts of stearic acid, 5 parts of anti-wet skid resin, 1.5 parts of anti-aging agent 4020, 1.5 parts of anti-aging agent RD, and 1.5 parts of protective wax were fed into an internal mixer and mixed for 20 seconds. The internal mixer was operated at a rotation speed of 45 rpm, and a ram pressure of 50 N/cm². When the mixing temperature was 155-165° C., the rubber was discharged as sheets, to obtain a two-stage master batch; and

the two-stage master batch, 1.5 parts of sulfur, and 1.3 parts of promoter NS were fed into an internal mixer and mixed for 25 seconds. The internal mixer was operated at a rotation speed of 22 rpm, and a ram pressure of 42 N/cm². When the mixing temperature was 105° C., the rubber was discharged as sheets, to obtain a tread rubber.

### Example 2

70 parts of natural rubber, 30 parts of solution polymerized styrene butadiene rubber with dual glass transition temperatures, 25 parts of carbon black, 15 parts of white carbon black with a high specific surface area, and 1.5 parts of silane coupling agent were fed into an internal mixer and mixed for 45 seconds. The internal mixer was operated at a rotation speed of 50 rpm, and a ram pressure of 50 N/cm². The ram was lifted twice and held for 10 seconds each time. When the mixing temperature was 150° C., the rubber was discharged as sheets, to obtain a one-stage master batch;
the one-stage master batch, 25 parts of carbon black, 3 parts of zinc oxide, 2 parts of stearic acid, 5 parts of anti-wet skid resin, 1.5 parts of anti-aging agent 4020, 1.5 parts of anti-aging agent RD, and 1.5 parts of protective wax were fed into an internal mixer and mixed for 20 seconds. The internal mixer was operated at a rotation speed of 45 rpm, and a ram pressure of 50 N/cm². When the mixing temperature was 160° C., the rubber was discharged as sheets, to obtain a two-stage master batch; and
the two-stage master batch, 1.5 parts of sulfur, and 1.4 parts of promoter NS were fed into an internal mixer and mixed for 25 seconds. The internal mixer was operated at a rotation speed of 23 rpm, and a ram pressure of 42 N/cm². When the mixing temperature was 105° C., the rubber was discharged as sheets, to obtain a tread rubber.

### Example 3

70 parts of natural rubber, 30 parts of solution polymerized styrene butadiene rubber with dual glass transition temperatures, 25 parts of carbon black, 15 parts of white carbon black with a high specific surface area, and 1.5 parts of silane coupling agent were fed into an internal mixer and mixed for 45 seconds. The internal mixer was operated at a rotation speed of 50 rpm, and a ram pressure of 50 N/cm². The ram was lifted twice and held for 10 seconds each time. When the mixing temperature was 150° C., the rubber was discharged as sheets, to obtain a one-stage master batch;
the one-stage master batch, 25 parts of carbon black, 3 parts of zinc oxide, 2 parts of stearic acid, 5 parts of modified anti-wet skid resin, 1.5 parts of anti-aging agent 4020, 1.5 parts of anti-aging agent RD, and 1.5 parts of protective wax were fed into an internal mixer and mixed for 20 seconds. The internal mixer was operated at a rotation speed of 45 rpm, and a ram pressure of 50 N/cm². When the mixing temperature was 160° C., the rubber was discharged as sheets, to obtain a two-stage master batch; and
the two-stage master batch, 1.5 parts of sulfur, and 1.4 parts of promoter NS were fed into an internal mixer and mixed for 25 seconds. The internal mixer was operated at a rotation speed of 22 rpm, and a ram pressure of 42 N/cm². When the mixing temperature was 105° C., the rubber was discharged as sheets, to obtain a tread rubber.

### Example 4

60 parts of natural rubber, 40 parts of solution polymerized styrene butadiene rubber with dual glass transition temperatures, 23 parts of carbon black, 20 parts of white carbon black with a high specific surface area, and 2.4 parts of silane coupling agent were fed into an internal mixer and mixed for 45 seconds. The internal mixer was operated at a rotation speed of 50 rpm, and a ram pressure of 50 N/cm². The ram was lifted twice and held for 10 seconds each time. When the mixing temperature was 150° C., the rubber was discharged as sheets, to obtain a one-stage master batch;
the one-stage master batch, 23 parts of carbon black, 3 parts of zinc oxide, 2 parts of stearic acid, 8 parts of modified anti-wet skid resin, 1.5 parts of anti-aging agent 4020, 1.5 parts of anti-aging agent RD, and 1.5 parts of protective wax into an internal mixer and mix for 10-30 seconds. The internal mixer was operated at a rotation speed of 45 rpm, and a ram pressure of 50 N/cm². When the mixing temperature was 160° C., the rubber was discharged as sheets, to obtain a two-stage master batch; and
the two-stage master batch, 1.4 parts sulfur, and 1.5 parts of promoter NS were fed into an internal mixer and mixed for 25 seconds. The internal mixer was operated at a rotation speed of 22 rpm, and a ram pressure of 42 N/cm². When the mixing temperature was 105° C., the rubber was discharged as sheets, to obtain a tread rubber.

### Example 5

50 parts of natural rubber, 50 parts of solution polymerized styrene butadiene rubber with dual glass transition temperatures, 21 parts of carbon black, 20 parts of white carbon black with a high specific surface area, and 2.4 parts of silane coupling agent were fed into an internal mixer and mixed for 45 seconds. The internal mixer was operated at a rotation speed of 50 rpm, and a ram pressure of 50 N/cm². The ram was lifted twice and held for 10 seconds each time. When the mixing temperature was 150° C., the rubber was discharged as sheets, to obtain a one-stage master batch;
the one-stage master batch, 21 parts of carbon black, 3 parts of zinc oxide, 2 parts of stearic acid, 10 parts of modified anti-wet skid resin, 1.5 parts of anti-aging agent 4020, 1.5 parts of anti-aging agent RD, and 1.5 parts of protective wax were fed into an internal mixer and mixed for 20 seconds. The internal mixer was operated at a rotation speed of 45 rpm, and a ram pressure of 50 N/cm². When the mixing temperature was 160° C., the rubber was discharged as sheets, to obtain a two-stage master batch; and
the two-stage master batch, 1.4 parts sulfur, and 1.5 parts of promoter NS were fed into an internal mixer and mixed for 25 seconds. The internal mixer was operated at a rotation speed of 22 rpm, and a ram pressure of 42 N/cm². When the mixing temperature was 105° C., the rubber was discharged as sheets, to obtain a tread rubber.

### Comparative Example 1

70 parts of natural rubber, 30 parts of solution polymerized styrene butadiene rubber with a low glass transition temperature, 25 parts of carbon black, 15 parts of highly dispersed white carbon black, and 1.2 parts of silane coupling agent were fed into an internal mixer and mixed for 45 seconds. The internal mixer was operated at a rotation speed of 50 rpm, and a ram pressure of 50 N/cm². The ram was lifted twice and held for 10 seconds each time. When the mixing temperature was 150° C., the rubber was discharged as sheets, to obtain a one-stage master batch;
the one-stage master batch, 25 parts of carbon black, 3 parts of zinc oxide, 2 parts of stearic acid, 5 parts of anti-wet skid resin, 1.5 parts of anti-aging agent 4020, 1.5 parts of anti-aging agent RD, and 1.5 parts of protective wax were fed into an internal mixer and mixed for 20 seconds. The internal mixer was operated at a rotation speed of 45 rpm, and a ram pressure of 50 N/cm². When the mixing temperature was 160° C., the rubber was discharged as sheets, to obtain a two-stage master batch; and
the two-stage master batch, 1.5 parts of sulfur, and 1.3 parts of promoter NS were fed into an internal mixer and mixed for 25 seconds. The internal mixer was operated at a rotation speed of 22 rpm, and a ram pressure of 42 N/cm². When the mixing temperature was 105° C., the rubber was discharged as sheets, to obtain a tread rubber.

TABLE 1
Composition of Comparative example 1 and Examples 1-5

| | Comparative | Example | Example | Example | Example | Example |
|---|---|---|---|---|---|---|
| Materials | example 1 | 1 | 2 | 3 | 4 | 5 |

Non-productbility

| | | | | | | |
|---|---|---|---|---|---|---|
| Natural | 70 | 70 | 70 | 70 | 60 | 50 |
| rubber | | | | | | |
| Solution | 30 | | | | | |
| polymerized | | | | | | |
| styrene | | | | | | |
| butadiene | | | | | | |
| rubber with a | | | | | | |
| low Tg | | | | | | |
| Solution | | 30 | 30 | 30 | 40 | 50 |
| polymerized | | | | | | |
| styrene | | | | | | |
| butadiene | | | | | | |
| rubber with | | | | | | |
| dual Tg | | | | | | |
| Carbon black | 50 | 50 | 50 | 50 | 46 | 42 |
| Highly | 15 | 15 | | | | |
| dispersed | | | | | | |
| white carbon | | | | | | |
| black | | | | | | |
| White carbon | | | 15 | 15 | 20 | 20 |
| black with a | | | | | | |
| high specific | | | | | | |
| surface area | | | | | | |
| Silane | 1.2 | 1.2 | 1.5 | 1.5 | 2.4 | 2.4 |
| coupling | | | | | | |
| agent | | | | | | |
| Anti-wet skid | 5 | 5 | 5 | | | |
| resin | | | | | | |
| Modified | | | | 5 | 8 | 10 |
| anti-wet skid | | | | | | |
| resin | | | | | | |
| Anti-aging | 1.5 | 1.5 | 1.5 | 1.5 | 1.5 | 1.5 |
| agent 4020 | | | | | | |
| Anti-aging | 1.5 | 1.5 | 1.5 | 1.5 | 1.5 | 1.5 |
| agent RD | | | | | | |
| Protective | 1.5 | 1.5 | 1.5 | 1.5 | 1.5 | 1.5 |
| wax | | | | | | |
| Zinc oxide | 3 | 3 | 3 | 3 | 3 | 3 |
| Stearic acid | 2 | 2 | 2 | 2 | 2 | 2 |

Productbility

| | | | | | | |
|---|---|---|---|---|---|---|
| Sulfur | 1.5 | 1.5 | 1.5 | 1.5 | 1.4 | 1.4 |
| Promoter NS | 1.3 | 1.3 | 1.4 | 1.4 | 1.5 | 1.5 |

The tread rubber with the ingredients specified in Table 1 were prepared in a BR Banbury mixer. The preparing process included three separate feeding and mixing stages, namely two non-producibility mixing stages and one producibility mixing stage. Two non-producibility stages were completed by performing mixing for about 2-3 minutes each, until the rubber temperature reaches 150-155° C. and 155-165° C., respectively. The producibility stage was completed by performing mixing for about 1-1.5 minutes until the rubber temperature reaches 100-110° C.

TABLE 2
Mechanical and Physical Properties of Comparative Example 1 and Examples 1-5

| | Comparative | Example | Example | Example | Example | Example |
|---|---|---|---|---|---|---|
| Materials | example 1 | 1 | 2 | 3 | 4 | 5 |
| Hardness Sh. A | 62 | 61 | 60 | 60 | 61 | 59 |
| Tensile strength | 28.2 | 28.0 | 28.3 | 27.9 | 28.5 | 27.9 |
| MPa | | | | | | |
| Fracture | 540 | 520 | 517 | 525 | 522 | 530 |
| elongation % | | | | | | |
| 300% tensile | 12.5 | 13.3 | 13.5 | 13.4 | 13.2 | 12.8 |
| stress % | | | | | | |
| Akron abrasion | 0.155 | 0.128 | 0.115 | 0.120 | 0.112 | 0.143 |
| cm³/1.61 km | | | | | | |
| Tg ° C. | −57 | −59/−25 | −60/−24 | −61/−25 | −61/−27 | −62/−26 |
| E′ (−25° C.) | 20.1 | 15.8 | 16.1 | 14.5 | 13.8 | 13.5 |
| Tanδ (0° C.) | 0.195 | 0.237 | 0.255 | 0.268 | 0.262 | 0.271 |
| Tanδ (60° C.) | 0.105 | 0.089 | 0.091 | 0.090 | 0.086 | 0.088 |

Table 2 shows the physical and mechanical properties of the above Comparative examples and Examples. All properties of the rubber material are tested according to national or industry standards, and the vulcanization condition of the rubber material is 151° C.×30 min; Among them, the dynamic mechanical performance test performed by characterizing temperature scanning of the vulcanized rubber using a dynamic viscoelastic spectrometer (DMA) produced by GABO company in Germany. The test conditions are as follows: compression mode, frequency 10 Hz, static strain 5%, dynamic strain 0.2%, temperature range of from −70° C. to 70° C., and heating rate 2° C./min.

Usually, the elastic modulus E′ at −25° C. is used to characterize the grip force on ice and snow ground, and the lower the value, the lower the modulus and the better the grip performance on ice and snow ground; the anti-wet skid performance is characterized using tan δ at 0° C., and the higher the values, the stronger the anti-wet skid performance; the heat generation performance of the rubber material is characterized by tan δ at 60° C., and the lower the value, the lower the heat generation of the rubber material, that is, the lower the rolling resistance of the tires.

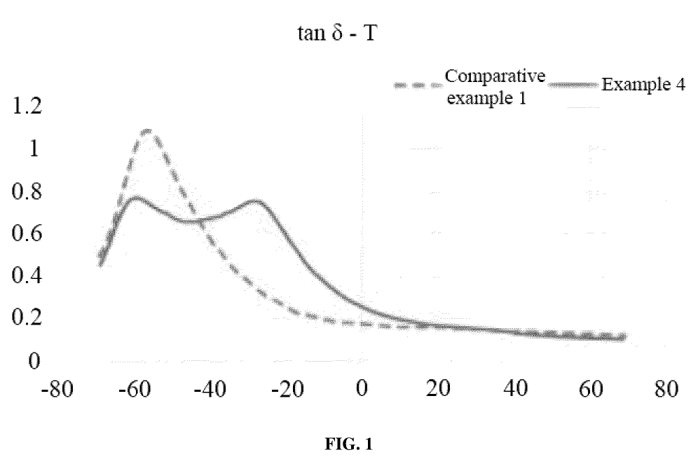

From Table 2 and FIG. 1, it can be seen that the solution polymerized styrene butadiene rubber with low peak and dual glass transition temperatures Tg can adjust the Tg and DMA curve peak shape of the tread rubber, reduce the Tg of the tread rubber, increase tan δ at −25° C. and 0° C., decrease E′ at −25° C., decrease tan δ at 60° C., improve the grip on ice and snow ground and anti-wet skid performance of the tread rubber, and reduce heat generation and improve wear resistance; the white carbon black with a high specific area can penetrate water films, provide anti-wet skid performance, enhance rubber reinforcement performance, and significantly improve wear resistance compared to highly dispersed white carbon black; and copolymer resin of modified styrene and dicyclopentadiene can improve anti-wet skid performance and reduce rolling resistance.

TABLE 3
Performance test data of trial produced 12R22.5 specification all-steel
snow tire of tread rubber for Comparative example 1 and Examples 3-44

| | | | | ECE-R117 | |
|---|---|---|---|---|---|
| | Compar- | | | Regulatory | ECE-R117 |
| | ative | | | standards | Regulatory |
| Test | exam- | Exam- | Exam- | (Four season | standards |
| project | ple 1 | ple 3 | ple 4 | tires) | (Snow tires) |
| Rolling | 6.5 | 6.0 | 5.9 | ≤6.5 | ≤7.5 |
| resistance | | | | | |
| N/KN | | | | | |
| Wet | 1.00 | 1.11 | 1.17 | ≥0.95 | ≥0.85 |
| ground | | | | | |
| grip | | | | | |
| index | | | | | |
| Snow | 1.49 | 1.60 | 1.68 | / | ≥1.25 |
| ground | | | | | |
| grip | | | | | |
| index | | | | | |
| Road | 350,000 | 440,000 | 430,000 | / | / |
| wear | km | km | km | | |
| mileage | | | | | |
| of tires | | | | | |

Table 3 shows the performance test data of 12R22.5 specification all-steel snow tires produced using the tread rubber of Comparative Example 1 and Examples 3-4. The rolling resistance of tires is tested at the National Engineering Laboratory, and the snow performance is tested at the Heilongjiang Honghe Valley Automotive Testing Center according to the ECE-R117 regulation. The wear performance of tires is tested according to GB/T 29041-2012.

From Table 3, as can be seen that the all-steel snow tires produced from the tread rubber prepared in Examples 3 and 4 have significant advantages in rolling resistance, anti-wet skid performance, snow ground performance, wear resistance, etc., which can achieve the optimal balance of various performance indicators of the tread rubber.

In summary, the present application utilizes solution polymerized styrene butadiene rubber with dual glass transition temperatures, white carbon black with a high specific area, copolymer resin of modified styrene and dicyclopentadiene, and optimizes the ratio of each component. The all-steel tread rubber prepared by mixing production has two glass transition temperatures, with a first glass transition temperature of less than or equal to −60° C., suitable for cold regions, and a second glass transition temperature of less than or equal to −20° C. and greater than or equal to −40° C., having a low modulus at low temperatures, a strong grip on icy and snowy road, and wet ground, low rolling resistance, far exceeding the requirements of ECE-R117 regulations for tire rolling resistance, snow grip index, and wet ground grip index. The wear resistance has been improved by more than 20%, meeting the requirements of tires for use in cold regions and for fuel saving and high wear mileage after severe winter or when the users driving to non-cold regions across regions.

Finally, it should be noted that the above examples are only used to illustrate the technical solution of the present application, and not to limit it. Although the present application has been described in detail with reference to the above examples, those skilled in the art should understand that they can still modify the technical solutions described in the above examples, or equivalently replace some of the technical features. And these modifications or substitutions do not make the essence of corresponding technical solutions depart from the spirit and scope of the technical solutions of the examples of the present application.

What is claimed is:

1. An all-steel snow tire tread, consisting of the following raw materials in parts by weight: 50-80 parts of natural rubber, 20-50 parts of solution polymerized styrene butadiene rubber with dual glass transition temperatures, 40-60 parts of carbon black, 10-20 parts of white carbon black with a high specific surface area, 1-2.5 parts of silane coupling agent, 5-10 parts of modified anti-wet skid resin, 2-5 parts of zinc oxide, 1-3 parts of stearic acid, 1-3 parts of anti-aging agent 4020, 1-3 parts of anti-aging agent RD, 1-3 parts of protective wax, 1-1.8 parts of sulfur, and 1-1.5 parts of promoter NS; the carbon black is N115 or N220;
the white carbon black with a high specific surface area has a specific surface area of 220-300 m²/g determined by BET and an absorption value of dibutyl phthalate of 250-300 cm³/100 g;
the silane coupling agent is Si-75, and a weight ratio of the silane coupling agent to the white carbon black with a high specific surface area is 1:10-1.4:10;
the modified anti-wet skid resin is a copolymer resin of modified styrene and dicyclopentadiene;
a preparation method for the all-steel snow tire tread is as follows:
(a) feeding the natural rubber, the solution polymerized styrene butadiene rubber with dual glass transition temperatures, a part of the carbon black, the white carbon black with a high specific surface area, and the silane coupling agent into an internal mixer for mixing for 40-50 seconds, the internal mixer is operated at a rotation speed of 40-55 rpm, and a ram pressure of 45-55 N/cm², lifting the ram and holding for 5-15 seconds twice, and discharging a rubber as sheets when a mixing temperature is 150-155° C., to obtain a one-stage master batch;
(b) feeding the one-stage master batch, rest of the carbon black, the zinc oxide, the stearic acid, the modified anti-wet skid resin, the anti-aging agent 4020, the anti-aging agent RD, and the protective wax into an internal mixer for mixing for 10-30 seconds, the internal mixer is operated at a rotation speed of 45-50 rpm, and a ram pressure of 45-55 N/cm², and discharging a rubber as sheets when a mixing temperature is 155-165° C., to obtain a two-stage master batch; and
(c) feeding the two-stage master batch, the sulfur, and the promoter NS into an internal mixer for mixing for 20-30 seconds, the internal mixer is operated at a rotation speed of 20-25 rpm, and a ram pressure of 40-45 N/cm², and discharging a rubber as sheets when a mixing temperature is 100-110° C., to obtain a tread rubber;
the solution polymerized styrene butadiene rubber with dual glass transition temperatures has dual glass transition temperatures, with a first Tg of less than −70° C. and a second Tg range from −55° C. to −35° C. and has a peak value of loss factor of lower than that of an ordinary solution polymerized styrene butadiene rubber with a single glass transition temperature having a low glass transition temperature.
